(19) United States
(12) Patent Application Publication
(10) Pub. No.: US 2013/0198113 A1
(43) Pub. Date: Aug. 1, 2013

(54) METHOD AND TECHNIQUE TO CREATE SINGLE INTELLIGENT COLLABORATION PLATFORM SPANNING ACROSS WEB, MOBILE AND CLOUD

(71) Applicants: Anirban Ray, Santa Clara, CA (US); Satadal Bhattalharjee, Fremont, CA (US)

(72) Inventors: Anirban Ray, Santa Clara, CA (US); Satadal Bhattalharjee, Fremont, CA (US)

(21) Appl. No.: 13/360,665

(22) Filed: Jan. 28, 2012

(51) Int. Cl. G06F 15/18

(52) U.S. Cl. 706/12

(57) ABSTRACT

A method that knits together and logically sequences diverse services such as, but not limited to, social networks, financial services, news feeds, email services, calendar services, analytical platforms and Business-to-consumer (B2C) services to create a state full cohesive end-to-end user experience on a single intelligent collaboration platform spanning across web, mobile and cloud.

### FIELD OF THE INVENTION

The present invention is directed generally toward creation of platform to unify and collaborate diverse services, and more particularly to services spanning across web, mobile, and cloud.

### BACKGROUND OF THE INVENTION

In the last decade numerous sites have surfaced in the web that offers different services. For instance there are sites for social networking, booking travels, sharing videos and pictures etc. Each of these sites offers specific services to the user. Users have to navigate multiple of these websites in order to achieve a particular task at hand. For example for booking a vacation with friends, users typically use social networking websites, such as Facebook/Twitter, to invite friends and check their availability to travel. In order to book travel, they use travel websites, such as Expedia. Once they return from travel users typically use video/photo sharing websites and/or social websites, such as YouTube/Facebook, to share their travel experience with their friends and families. User has to spend a lot of time and effort to navigate to multiple websites in order to achieve an end-to-end experience.

In the recent past few websites have surfaced that attempts to aggregate specific services. However they are either very specific to particular segment or not scalable enough to satisfy the greater need for an integrated platform.

As number of services in the web proliferates, so does the users overhead of navigating numerous websites before they can achieve their work. The present invention attempts to address these issues and go beyond that.

Consequently, it would be advantageous if a website existed that integrates various services and provides user with a common website to achieve their various tasks from a central location. Such a service needs to be highly adaptable and scalable to accommodate new services that are constantly being introduced. In addition it will be highly desirable for the service to be extensible across web and mobile and live in cloud.

### SUMMARY OF THE INVENTION

Accordingly, the present invention is directed to a novel method and architecture for creating a method that knits together and logically sequences diverse services such as, but not limited to, social networks, financial services, news feeds, email services, calendar services, analytical platforms and Business-to-Consumer (B2C) services to create a state full cohesive end-to-end user experience on a single intelligent collaboration platform spanning across web, mobile and cloud.

One embodiment of the present invention is a website that offers complete end-to-end vacation booking. The website takes travel dates and destination as input and takes care of contacting friends, booking flights/hotel, and sharing video/pictures on return. The website can also persist the entire travel for sharing and replication in future.

Another embodiment of the present invention includes a customized platform for business use. The platform can be customized to address specific needs for small to medium businesses such as a dentist office. The services in the site can send automatic reminders to patients reminding them of upcoming appointments promote the services in social media, integrate financial, email and other services that the dentist uses.

The possibilities are wide and the platform is entirely generic in nature. It has the ability to scale along with the proliferation of services in the web and mobile.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 shows a block diagram of the core components of the platform which comprises of the Workflow, SDK, App and Branding;

FIG. 2 shows a block diagram which shows Workflow Execution Engine, Widget Creation Wizard, Interface Definition Language, and Scripting;

FIG. 3 shows a block diagram of how the platform SDK hides API from various services and exposes an uniform API for usage;

FIG. 4 shows a block diagram of how users currently have to interact with multiple diverse websites to carry out a task such as planning a vacation;

FIG. 5 shows a block diagram of user can interact with the platform of current invention that hides interaction from discrete services;

FIG. 6 shows a block diagram of how users have to interact with multiple web services to satisfy their app's needs;

FIG. 7 shows a block diagram of users can interact with the platform which provides a common interface to all underlying web services;

FIG. 8 shows a block diagram of user has to use multiple websites in particular order in order to accomplish certain tasks such as planning a vacation with friends or scheduling events;

FIG. 9 shows a block diagram of how the invention interacts with various services behind the scene and allows user to use a single platform drastically simplifying user experience and time taken to complete the task;

FIG. 10 shows a block diagram of an example of FIG. 9 wherein user is trying to arrange a vacation with friends and has to use different websites such as social networking, travel and video/picture sharing websites to complete the entire flow;

FIG. 11 shows a block diagram of how the invention is using various modules internally to accomplish the complex tasks on behalf of the user;

FIG. 12 shows a block diagram of how the invention can persist user's state across logins

FIG. 13 shows a block diagram of how a user can start a workflow and leave prematurely

FIG. 14 shows a block diagram of how a user can retrieve and complete a workflow

FIG. 15 shows a block diagram that is an example to illustrate the generic flow outlined in FIG. 13

FIG. 16 shows a block diagram that is an example to illustrate the generic flow outlined in FIG. 14

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

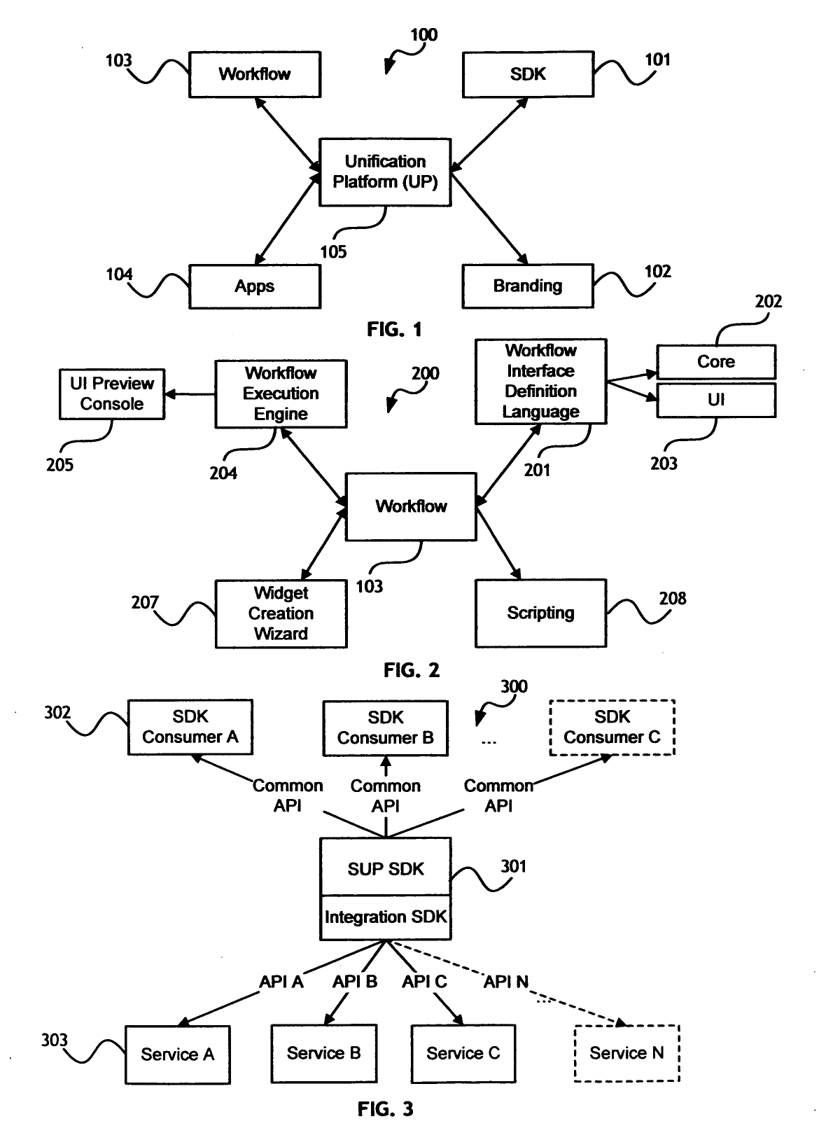

FIG. 1 shows the core components of the platform. It comprises of the following sub-components:
SDK—The SDK (Software development kit) 101 is the interface for developers to develop applications on the unified platform 105 as well as outside the platform with data linkage. 101 will provide a set of API (Application programming interface) to ease the application development. Some of these API will provide unified abstraction over API from different linked services and others will provide value added functionality from the collaboration platform perspective. The unified API will minimize the developer's effort by eliminating multiple touch points at different service access points. Also the API will take care of the variances in API data format from different services of similar family, and will provide a uniform data structure encapsulation. The SDK will also provide a meta-language which can be used to develop plugin applications on the platform with a uniform look and feel.
Workflow—The unification platform will provide the capability of defining user workflows 103. A workflow is a platform tool to compose end-to-end user stories. The purpose of a workflow is to allow the user to perform a set of related activities from a single window instead of performing each activity at different service access points. A workflow can be defined by tying discrete logical units, termed widget. Each widget is meant to capture a unit logical step in the user story. Each widget will have data and behaviour specific to it and can interact with other widgets to set up a meaningful sequence or relation.
Apps—are intended to provide an independent value added service to the platform. For instance there can be an app 104 that allow user to search and play publicly available videos from various services in the internet. Yet another app may allow user to search and share the top news of the day. Platform will allow developers to create app of their own and integrate them within the platform.
Branding—ability to customize the entire platform to create a specific instance for specific purposes. For instance the platform can be branded 102 as a platform to serve a small business of a dentist—schedule appointments, schedule and send reminders, integrate with social networking services to keep patients up to date on upcoming events such as vacations etc.

FIG. 2 shows detailed workflow sub-components and their interaction. It comprises of the following:
Workflow Execution Engine—at the core of the workflow 103 is its execution engine 204. It executes scripts written using a platform proprietary language called SWIDL which is based on XML. The unification platform will reduce development effort by providing a meta-language for UI definition. This will eliminate the tasks of tuning the look-and-feel, handling client behavioural differences etc. Along with the UI definition, there is provision to bind data and behaviour for the workflow units. The UI definition can be provided statically or dynamically. The Workflow execution engine 204 will intelligently render the UI from the meta-language definition and will enforce behaviours defined on the UI elements and associated data. The discreet workflow units will be seamlessly tied by the execution engine and will provide transparency to the end user from the underlying complexities.
Widget Creation Wizard—web based wizard that allows developers to create widgets by providing them with an interface to easily search and add available widgets. It also lets developers create new widget from scratch.
Scripting—allows developers to write scripts using platform proprietary scripting language. Helps developers automate and schedule tasks, perform operations that affect multiple entities.
Interface Definition language—XML based language that provides a series of tags using which developers can add new widgets or use existing widgets.

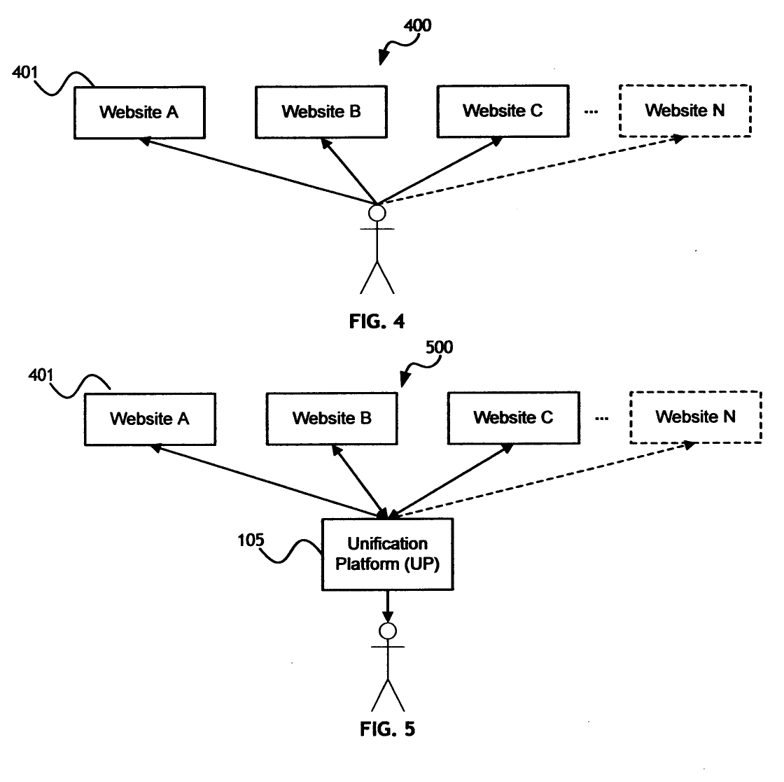

FIG. 3 shows how platform SDK encapsulates various diverse services and exposes a common API for external usage. The model is entirely scalable and allows addition of new services without breaking existing consumers. Currently a developer, who needs to use multiple services, has to connect to different API at different service access points. The data structures for different services of the same class are also different. The Unification platform will provide the developers a single access point through a unified API to reach out to the multiple services. The platform will have an infrastructure to translate the unified API to the underlying diverse service API and consolidate the fetched data in a uniform data structure.

FIG. 4 shows how users have to interact with multiple websites today in order to achieve their intended tasks. For instance booking a vacation needs visit to at least 3 to 4 websites or more depending upon the complexity of the vacation plan.

FIG. 5 shows how unification platform 105 abstracts multiple services and provides a unified interface to the user. The platform in turn leverages various services internally. This allows user to use a single website and hides the complexity of interacting with various websites. This saves user time and effort. The unification platform will provide users to compose their workflows. The workflow unit or widgets are supposed to provide the same functionality of a particular task on a website. The widget will communicate to the necessary service under the covers to get the specific task accomplished.

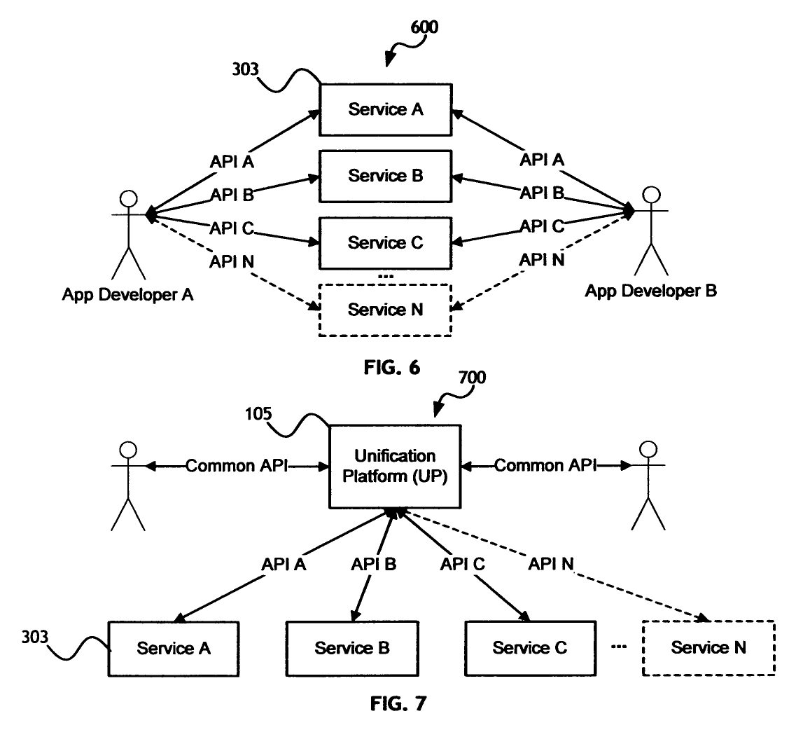

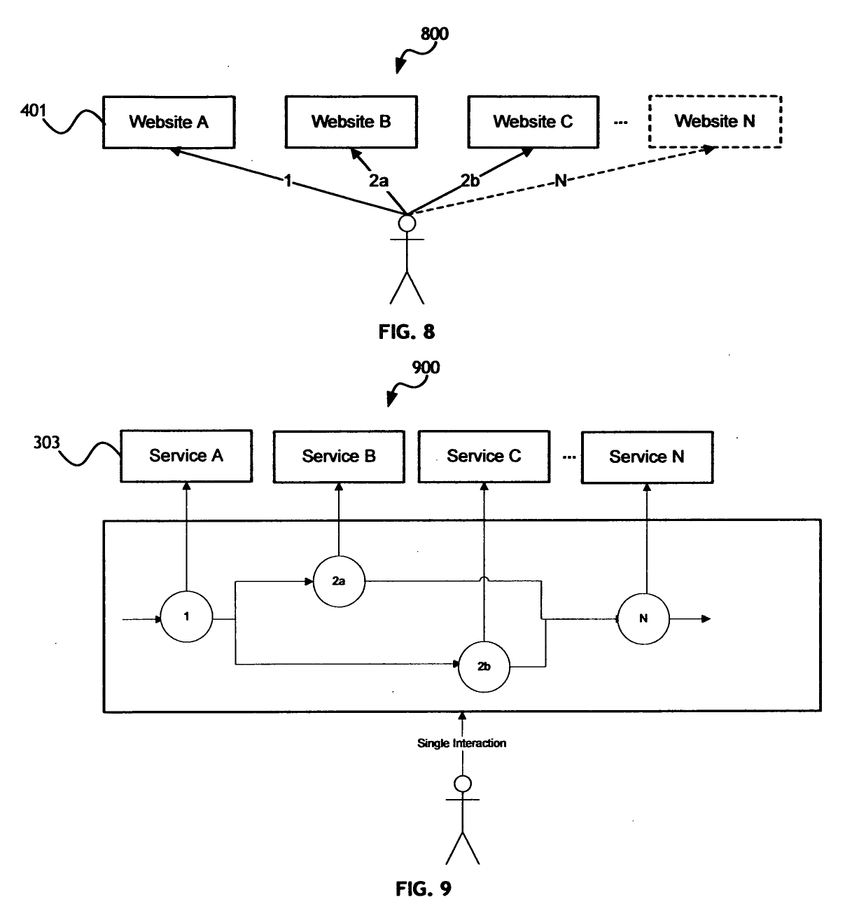

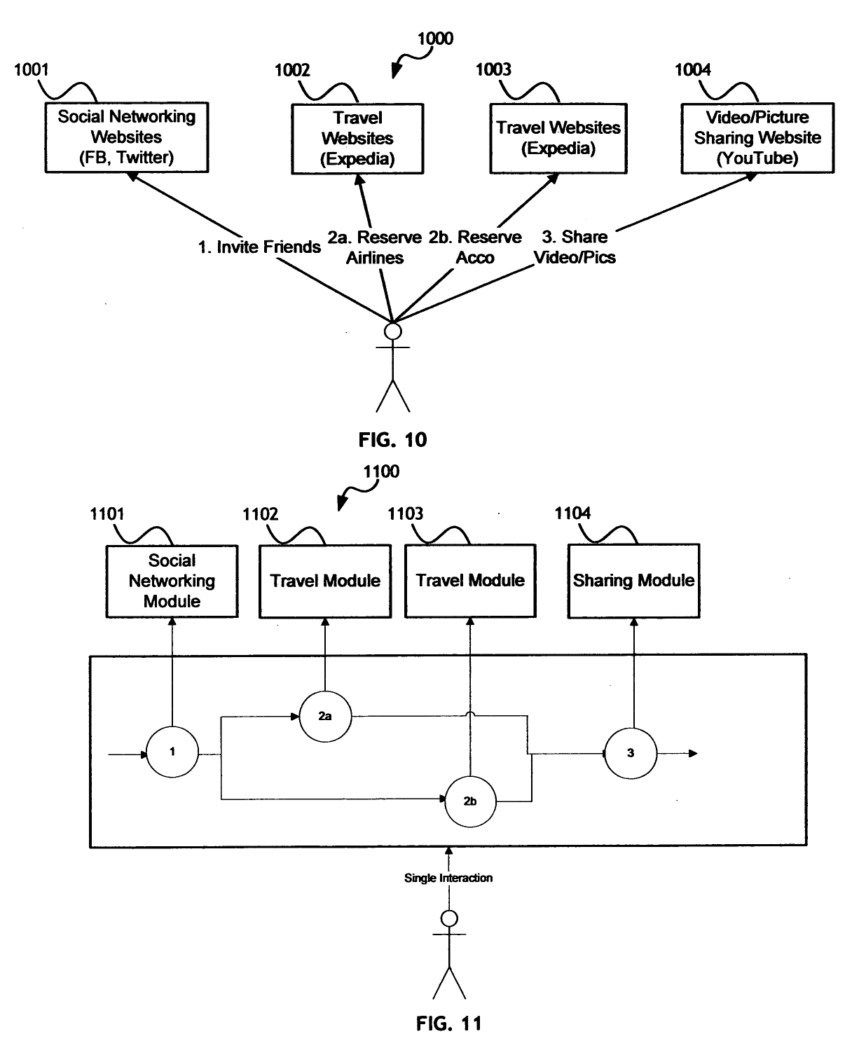

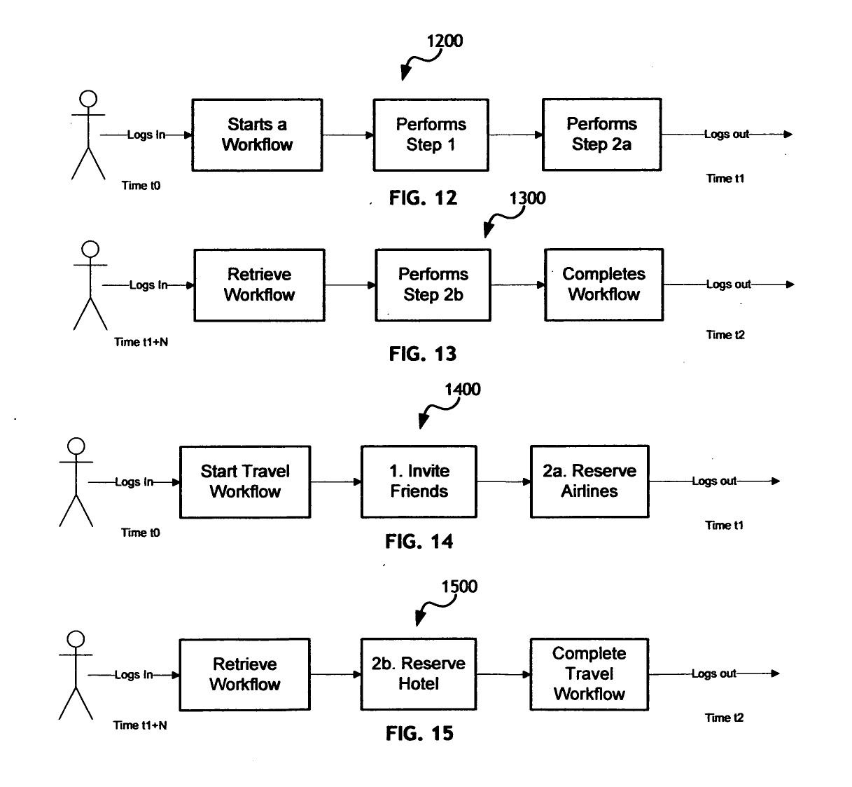

FIG. 6 shows how developers have to use multiple APIs from different services to fulfil their application needs. Developers have to keep track of any changes in any of these APIs to maintain integrity of their app

FIG. 7 shows how unification platform 105 provides a common API to developers to interact with. Developers need not worry about individual service APIs. Platform can use the best available service underneath to achieve its purpose completely abstracting the developer from individual services.

Platform scheduler provides a generic scheduling infrastructure to schedule any task within the platform. Some of the tasks that can be scheduled are
Social activity such as birthday reminder
Appointment reminder
Finance management
Notifications

Ability to share across workflow in multiple modes
Class sharing—In the class sharing mode, workflow definitions can be shared between different users. This mode of workflow sharing will provide users the ability to share a user story constitution at a higher protection level. The data associated with workflow units will not be shared between the users.
Selective object sharing—In the selective sharing mode, users will be able to share the workflow definition and data of some workflow units with other users. This will provide a medium level of protection level to the actual workflow instance.
Full object sharing—In the full object sharing mode, users will have the capability to share a workflow instance with data from all the workflow units with other users.

Ability to share across workflow in multiple modes

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method that knits together and logically sequences diverse services such as, but not limited to, social networks, financial services, news feeds, email services, calendar services, analytical platforms and Business-to-consumer (B2C) services to create a cohesive end-to-end user experience on a single intelligent collaboration platform spanning across web, mobile and cloud.
Dependent Claims:
i. Following statement in claim 1, the platform intelligently learns user behaviour and helps proactively in enriching the experience
ii. Pursuant to claim 1, based on user's current location, the platform proactively finds and recommends contents that match user's interest.
iii. Following statement in claim 1, a technique that allows user to integrate diverse, independent services to create a cohesive and logically sequenced workflow. Platform preserves the state of the services and brings the user back to the state in which the user last used the platform.
iv. Pursuant to claim 1, a technique that provides developers with a common API to access diverse independent services across web, mobile and cloud abstracting developers from individual API of those services.

2. A method to preserve, share and replicate the user experience across web, mobile and cloud as characterized by claim 1.

3. A method to extract existing and subscribe to future activities, updates, discussions for specific entities like people, topics, events etc. across, but not limited to, social networks, news services, blogs.
